(19) United States
(12) Patent Application Publication
(10) Pub. No.: US 2011/0165372 A1
(43) Pub. Date: Jul. 7, 2011

(54) Line sleeve

(76) Inventor: David Andrew Flood, Ft. Lauderdale, FL (US)

(21) Appl. No.: 12/930,285

(22) Filed: Jan. 3, 2011

Related U.S. Application Data
(60) Provisional application No. 61/335,221, filed on Jan. 4, 2010.

(51) Int. Cl. B32B 3/06

(52) U.S. Cl. 428/100

(57) ABSTRACT

This invention is an anti chafing device, called the Line Sleeve for use around boat lines. The invention is made of wool attached to a sheepskin backing. The invention uses hook and loop fasteners to secure the invention to the boat line. When attached to the line the invention acts as buffer between the line and the surface area of the boat. The line can no longer come in direct contact with the boat. Thus stopping any abrasions and chafeing that can damage the surface area of the boat.

References cited in filing of this patent

United States Patent

| | | |
|---|---|---|
| 3,117,371 | Farley | Jan. 14, 1964 |
| 6,092,482 | Danenbarger | Jul. 25, 2000 |

### BACKGROUND OF THE INVENTION

1. Field of the Invention

This application relates to chafing gear for boats. More specifically to prevent the damage caused to boats when the boats line rubs up against or chafes the surface area on a boat.

2. Prior Art

Originally this problem was addressed by wrapping a towel, rubber hose or some other type of material around the boat line. This was done to prevent the line from coming in contact with the boat, and causing damage. The problem with using these materials was securing the material to the boats line. When the boat would move in the wind, the lines would tighten or loosen. This caused the materials to slide on the line moving from their desired position. These materials were secured to the boat line with a string, rope, or zip ties. Because of this attachment method the material would inevitably slide on the line. Thus allowing the boat line to once again come in contact with the surface area of the boat, and rub up against it causing damage.

The closest patents I could find to my embodiment were U.S. Pat. No. 3,117,371 issued Jan. 14, 1964 and U.S. Pat. No. 6,092,482 issued Jul. 25, 2000. U.S. Pat. No. 3,117,371 was issued to stop the line from fraying, and failing. My application is concerned with stopping the line from rubbing up against the boat and causing damage. U.S. Pat. No. 6,092,482 was issued to stop mooring lines or anchor lines from chafing and breaking. My concern is not with having the line fray or break. My embodiment is specifically designed to protect the boats surface area from damaged caused by boat lines.

### ADVANTAGES

The advantages this embodiment has, is that said embodiment uses the hook and loop fastening system. Once the embodiment is wrapped around the boat line the hook and loop fasteners secure said embodiment in place. It is virtually impossible for said embodiment to slide or slip on the boats line.

### BRIEF SUMMARY OF THE INVENTION

Said embodiment acts as a protective buffer between any size or type of boat line and the boats surface area. Said embodiment wraps around the boat line, just like a sleeve. Said embodiment is then secured using the hook and loop fastening system. Once said embodiment is placed on the boat line, it will remain securely in place. Because of the hook and loop fasteners it is virtually impossible for said embodiment to slip or move out of its desired position. Said embodiment will remain in the proper position until removed. Thus stopping the line from coming in direct contact with the surface area of the boat. The embodiment itself is in contact with the surface area, and this stops the line from chafing or damaging the boat.

### BRIEF DESCRIPTION OF DRAWINGS

FIG. 1 shows the top or outside of said embodiment. The hook 10 and loop 12 fasteners are sewn onto the material 11. The material 11 is sheep's wool or any other suitable weather resistant material.

FIG. 2 shows the bottom or inside of said embodiment. 10 is the hook of the hook and loop fasteners and it is sewn down the middle of the inside of said embodiment. 13 is the sheepskin backing or other suitable weather resistant material.

FIG. 3 shows a side view of said embodiment when attached around the line. 15 is the boat line. 11 is the wool on the outside of said embodiment.

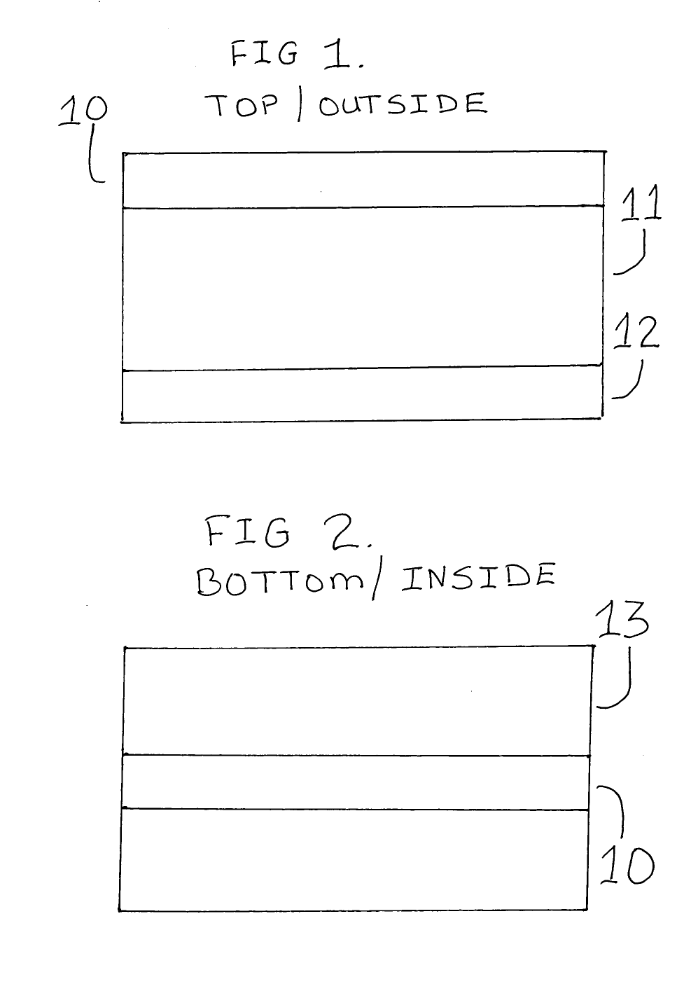

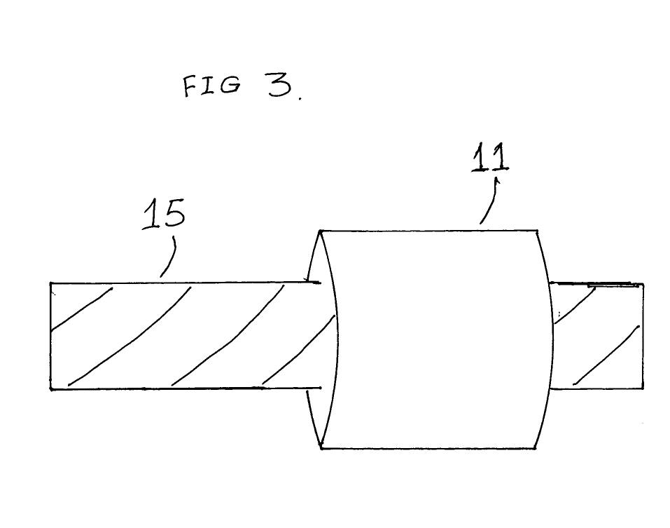

### DESCRIPTION OF THE PREFERRED EMBODIMENTS

I contemplate that said embodiment be either black or white and made of 100% sheep's wool comes attached to the sheepskins backing. However, any other weather resistant materials would be suitable. The length and width of said embodiment is predetermined with the wool being of substantial thickness. Said embodiment has a predetermined strip of hook from the hook and loop fastening system sewn on the inside of said embodiment. This hook is sewn from end to end on said embodiment. On the outside of said embodiment there is a predetermined piece of the hook and a predetermined piece of loop from the hook and loop fastener system sewn from end to end on the outer edges of the embodiment. When said embodiment is placed on the boat line the hook on the inside of the embodiment grips the boat line. This prevents said embodiment from slipping or sliding.

The hook and loop on the outside of the embodiment secures the embodiment in place when the embodiment is wrapped around the line. With the hook and loop attachment there is no need to tie said embodiment to the line. When attached the hook on the inside of the embodiment grips the line, preventing the embodiment from sliding on the line.

Having thus described the invention in preferred embodiment,

I claim:

1. A piece of anti chafing gear, for use on any size or type of boat line. The method of preventing the boat line from chafing or rubbing up against any surface area on the boat that the boat line would come in contact with. Said device compromising:
a. The material that is either black or white in color and of substantial length and width to fit any size or type of boat line and uses the hook and loop system to attach and secure said embodiment to the boat line.
b. Said hook and loop fasteners are sewn onto the outside edge of said material the hook and loop fasteners are to be sewn from end to end of said material.
c. Said embodiment also uses said hook of the hook and loop fasteners on the inside of said embodiment said hook is sewn from end to end down the middle of said embodiment.
